(19) United States
(12) Patent Application Publication
(10) Pub. No.: US 2015/0323129 A1
(43) Pub. Date: Nov. 12, 2015

(54) SELF-OILING PNEUMATIC TOOL

(71) Applicant: GRAIN POINT ENTERPRISE LTD., KEELUNG CITY (TW)

(72) Inventor: CHAO-MING KUO, KEELUNG CITY (TW)

(21) Appl. No.: 14/706,832

(22) Filed: May 7, 2015

(30) Foreign Application Priority Data
May 8, 2014 (TW) 103208014

(51) Int. Cl. F16N 7/30; B25F 5/00

(52) U.S. Cl. CPC F16N 7/30; B25F 5/00

(57) ABSTRACT

A self-oiling pneumatic tool includes a pneumatic tool assembly, in which a driver unit is mounted. The pneumatic tool assembly has an end forming an air connection terminal. An oiling unit is arranged between the driver unit and the air connection terminal and located in the pneumatic tool assembly and includes an outer tube hermetically enclosing an inner tube so that an oil preservation space is formed therebetween. The inner tube has a circumferential wall in which a second oil supply aperture is formed and in communication with a passage of the inner tube that is in communication with the driver unit. When external air is supplied through the inner tube to the driver unit, oil stored in the oil preservation space is allowed to flow through the second oil supply aperture into the passage of the inner tube to then flow to the driver unit to achieve self-oiling.

### TECHNICAL FIELD OF THE INVENTION

The present invention generally relates to a self-oiling pneumatic tool, and more particularly to a pneumatic tool that comprises an oiling unit arranged between a driver unit of the pneumatic tool and an air connection terminal to provide a self-oiling function.

### DESCRIPTION OF THE PRIOR ART

With the progress of industrial techniques and the increasing demand of the users, pneumatic tools are nowadays of increasing fast and vivid development and are widely used to replace the conventional manually operating tools.

For most of the pneumatic tools that are commonly used today, such as pneumatic drillers and pneumatic wrenches, those known pneumatic tools require the supply of pressurized air to drive the operation of the tools. The known pneumatic tool is provided in the interior thereof with a pneumatic motor and the pneumatic tool comprises an air connection terminal so as to connect to an external air compressor with the air connection terminal to receive the pressurized air supplied from the air compressor to be fed from the air connection terminal to the pneumatic motor inside the pneumatic tool to drive the pneumatic motor to rotate and thus achieving the operation of the pneumatic tool that is applicable to rotating a bolt or other workpieces.

The pneumatic motor arranged inside the pneumatic tool is operated in a high rotational speed and lubrication oil must be supplied to the pneumatic tool to protect the pneumatic motor from being damaged resulting from wear and abrasion. A conventional way of supplying lubrication oil is using an oiling device to feed lubrication oil through the air connection terminal of the pneumatic tool. When the pressurized air is supplied through the air connection terminal to the pneumatic motor inside the pneumatic tool, the lubrication oil entrains the pressurized air to be conveyed to the pneumatic motor inside the pneumatic tool so as to lubricate the pneumatic motor.

However, the conventional way of supplying lubrication oil requires the operation of feeding lubrication oil to be carried out constantly and repeatedly during the operation of the pneumatic tool in order to maintain the lubricated condition of the pneumatic motor. This requires the user to constantly pay attention to if the lubrication oil is timely supplied. Once the user forgets to timely supply the lubrication oil, the pneumatic motor may get damaged due to excessive wear and abrasion. This makes the use of the pneumatic tool very inconvenient.

### SUMMARY OF THE INVENTION

In view of the above problems, the present invention provides a self-oiling pneumatic tool, which comprises an oiling unit arranged between a driver unit of the pneumatic tool and an air connection terminal, whereby the oiling unit may supply lubrication oil in a timely and quantitative manner to the driver unit to achieve a self-oiling function of the pneumatic tool according to the present invention.

The self-oiling pneumatic tool according to the present invention comprises a pneumatic tool assembly. The pneumatic tool assembly comprises a driver unit arranged therein. The pneumatic tool assembly has an end forming an air connection terminal. An oiling unit is arranged between the driver unit and the air connection terminal. The oiling unit is mounted inside the pneumatic tool assembly and comprises an outer tube and an inner tube with the outer tube hermetically enclosing outside the inner tube so that an oil preservation space is formed between the outer tube and the inner tube. The inner tube has a circumferential wall in which a second oil supply aperture is formed. The second oil supply aperture is in communication with a passage of the inner tube and the passage of the inner tube is in communication with the driver unit.

The efficacy of the present invention is that when external pressurized air is supplied through the inner tube of the oiling unit to the driver unit, oil (such as lubrication oil) contained in the oil preservation space is allowed to flow through the second oil supply aperture into the passage of the inner tube and then flow from the passage of the inner tube into the driver unit arranged inside the pneumatic tool assembly to achieve lubrication of the driver unit. With a predetermined amount of oil stored in the oiling unit, each time when the pneumatic tool assembly is activated, the oil contained in the oiling unit can be fed out in a quantitative manner so that the oiling unit supply the oil, in a timely and quantitative manner, to the driver unit to lubricate the driver unit thereby achieving an effect of self-oiling.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a pneumatic tool according to a first embodiment of the present invention.

FIG. 2 is an exploded view of the pneumatic tool according to the first embodiment of the present invention.

FIG. 3 is a cross-sectional view of the pneumatic tool according to the first embodiment of the present invention viewed at a perspective.

FIG. 4 is a cross-sectional view of the pneumatic tool according to the first embodiment of the present invention viewed at another perspective.

FIG. 5 is a schematic view showing the use of the pneumatic tool according to the first embodiment of the present invention.

FIG. 6 is a perspective view showing a pneumatic tool according to a second embodiment of the present invention.

FIG. 7 is a perspective view showing a pneumatic tool according to a third embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

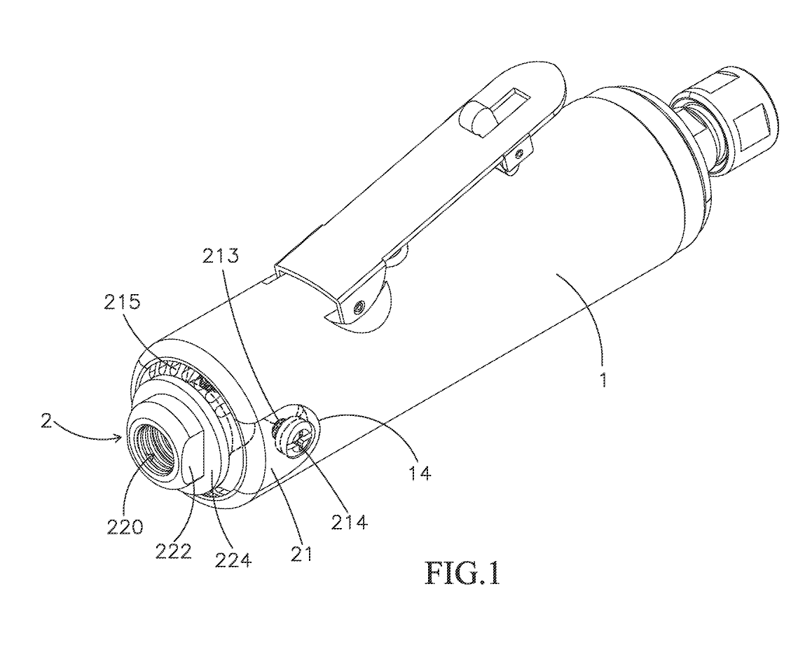

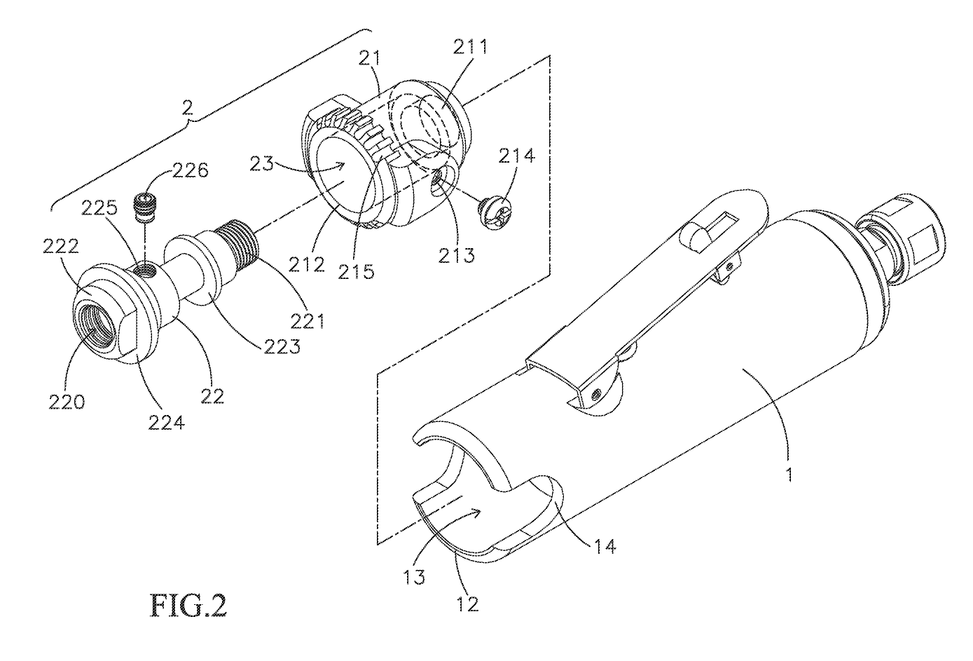

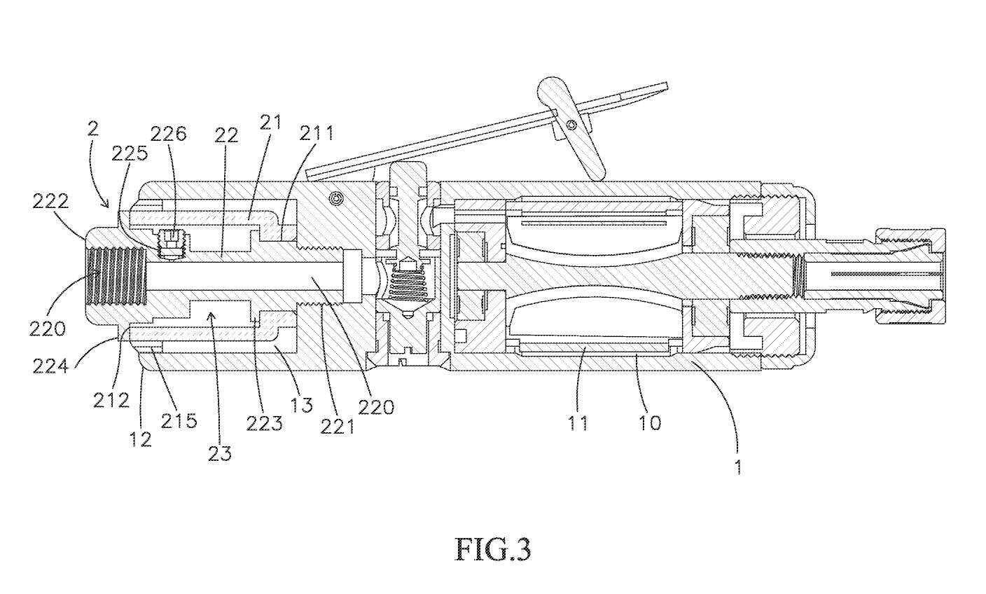

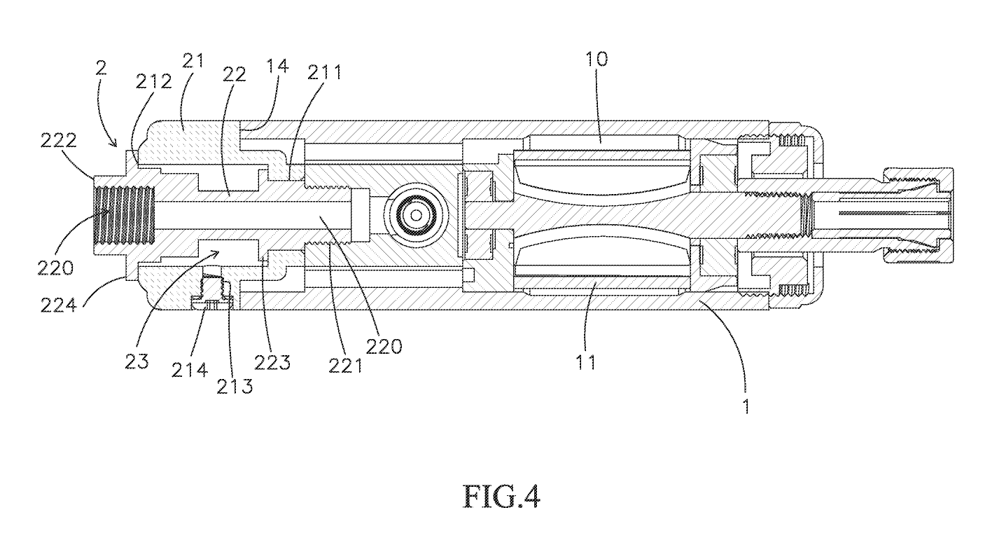

Referring to FIGS. 1-4, the present invention discloses a self-oiling pneumatic tool, which comprises a pneumatic tool assembly 1 and an oiling unit 2.

The pneumatic tool assembly 1 comprises an air compartment 10 formed therein and a driver unit 11 mounted in the air compartment 10. The pneumatic tool assembly 1 has an end forming an air connection terminal 12 in such a way that the air connection terminal 12 is in communication with the air compartment 10 to allow pressurized air to be introduced through the air connection terminal 12 to the air compartment 10 so that the pressurized air may drive the driver unit 11 to rotate. The pneumatic tool assembly 1 comprises a receiving space 13 formed between the driver unit 11 and the air connection terminal 12 and the receiving space 13 is also in communication with the air compartment 10. Further, the pneumatic tool assembly 1 comprises at least one hollowed section 14 formed in an external wall thereof at a location corresponding to the receiving space 13. The driver unit 11 can be for example a pneumatic motor.

The oiling unit 2 is arranged between the driver unit 11 and the air connection terminal 12 of the pneumatic tool assembly 1. For example, the oiling unit 2 can be arranged in the receiving space 13 of the pneumatic tool assembly 1. The oiling unit 2 comprises an outer tube 21 and an inner tube 22. The outer tube 21 hermetically encloses outside of the inner tube 22.

The outer tube 21 has an end forming a first opening 211 and an opposite end forming a second opening 212 and a circumferential wall in which at least one first oil supply aperture 213 is formed at a location between the first opening 211 and the second opening 212. The first oil supply aperture 213 extends into and in communication with the interior of the outer tube 21. The outer tube 21 is also provided with a sealing member 214. The sealing member 214 is mounted in the first oil supply aperture 213 so that the sealing member 214 may close and seal the first oil supply aperture 213. Further, the outer tube 21 comprises a plurality of air guide holes 215 that is formed by recessing an outside surface thereof. The plurality of air guide holes 215 is arranged side by side. The outer tube 21 can be a transparent or translucent tube.

The inner tube 22 has an end forming a first coupling end 221 and an opposite end forming a second coupling end 222. The first coupling end 221 is arranged to face the air compartment 10 of the pneumatic tool assembly 1 and the second coupling end 222 corresponds to the air connection terminal 12 of the pneumatic tool assembly 1. The inner tube 22 comprises a first sealing section 223 mounted thereon at a location adjacent to the first coupling end 221. The inner tube 22 also comprises a second sealing section 224 mounted thereto at a location adjacent to the second coupling end 222. The first sealing section 223 is circular and has an outside diameter that is greater that an inside diameter of the first opening 211 in order to selectively close and seal the first opening 211 of the outer tube 21. The second sealing section 224 is circular and has an outside diameter that is greater than an inside diameter of the second opening 212 in order to close and seal the second opening 212 of the outer tube 21. The inner tube 22 comprises a passage 220 therein and the passage 220 is in communication with both the first coupling end 221 and the second coupling end 222. The passage 220 is also in communication with the air compartment 10 and the driver unit 11 of the pneumatic tool assembly 1. Further, the inner tube 22 has a circumferential wall in which at least one second oil supply aperture 225 is formed at a location between the first coupling end 221 and the second coupling end 222. The second oil supply aperture 225 is in communication with the passage 220. The inner tube 22 also comprises a plug 226 and the plug 226 is mounted in the second oil supply aperture 225. The plug 226 is made of one or more one kinds of polymer in such a way that gaps are formed between the polymers of the plug 226 to provide the plug 226 with permeability.

The outer tube 21 is arranged to hermetically enclose the outside of the inner tube 22 in such a way that an oil preservation space 23 is formed between an inside surface of the outer tube 21 and an outside surface of the inner tube 22. The first oil supply aperture 213 of the outer tube 21 is in communication with the oil preservation space 23 and the second oil supply aperture 225 of the inner tube 22 is also in communication with the oil preservation space 23. Oil (such as lubrication oil) can be fed through the first oil supply aperture 213 of the outer tube 21 into the oil preservation space 23 and then, the sealing member 214 may be applied to close and seal the first oil supply aperture 213 to preserve the oil in the oil preservation space 23.

An example will be given as follows for explaining the present invention. Pressurized air is introduced from the second coupling end 222 of the inner tube 22 into the passage 220. The pressurized air permeates through the plug 226 of the inner tube 22 into the oil preservation space 23, whereby when the air pressure inside the passage 220 corresponds to the pressure inside the oil preservation space 23, the oil contained in the oil preservation space 23 is prevented from permeating outward through the plug 226; and when the pneumatic tool assembly 1 is activated, the air pressures inside the passage 220 gets reduced to a level lower than the pressure inside the oil preservation space 23 and under such a condition, the oil contained in the oil preservation space 23 permeates through the plug 226 into the passage 220 so that the oil may entrain the pressurized air to move from the passage 220 of the inner tube 22 into the air compartment 10 of the pneumatic tool assembly 1 to lubricate the driver unit 11 arranged in the pneumatic tool assembly 1. As such, with a predetermined amount of oil preserved in the oil preservation space 23 of the oiling unit 2, each time when the pneumatic tool assembly 1 is activated, the oil stored in the oiling unit 2 is allowed to permeate and feed, in a quantitative manner, into the passage 220 to then flow into the driver unit 11 inside the pneumatic tool assembly 1 for lubrication. Through oil fed from the oiling unit 2 in a timely and quantitative manner into the driver unit 11 of the pneumatic tool assembly 1, an effect of self-oiling can be achieved to help constantly maintain the driver unit 11 of the pneumatic tool assembly 1 in a lubricated manner.

Air that enters the air compartment 10 of the pneumatic tool assembly 1 is then guided to the receiving space 13 to eventually discharge through the plurality of air guide holes 215 formed in the outer tube 21.

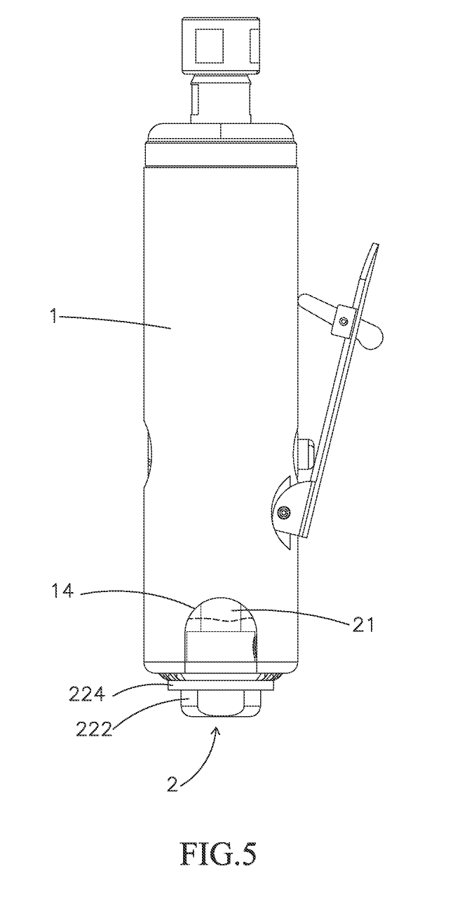

It is noted that the pneumatic tool assembly 1 is provided with at least one hollowed section 14 formed in an external wall thereof at a location corresponding to the receiving space 13 so that the hollowed section 14 also corresponds in position to the outer tube 21 of the oiling unit 2. In addition, the outer tube 21 is a transparent or translucent tube, which allows a user to use the hollowed section 14 as an observation window to timely observe the residual amount of the oil contained in the oil preservation space 23 of the oiling unit 2 (as illustrated in FIG. 5).

The first coupling end 221 of the inner tube 22 may be provided with a thread on an outside surface thereof to allow the oiling unit 2 to coupled to the pneumatic tool assembly 1 through screwing engagement achieved with the first coupling end 221. The second coupling end 222 of the inner tube 22 is connectable with an external air compressor.

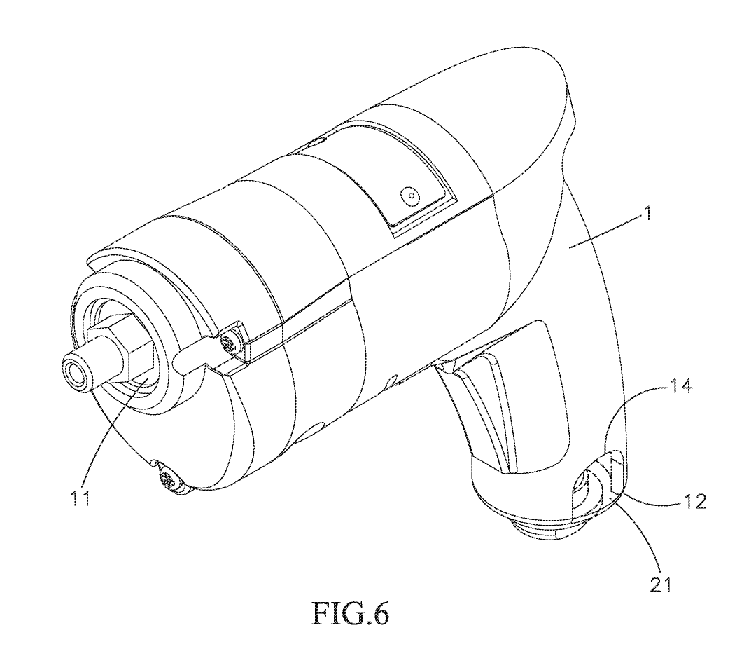

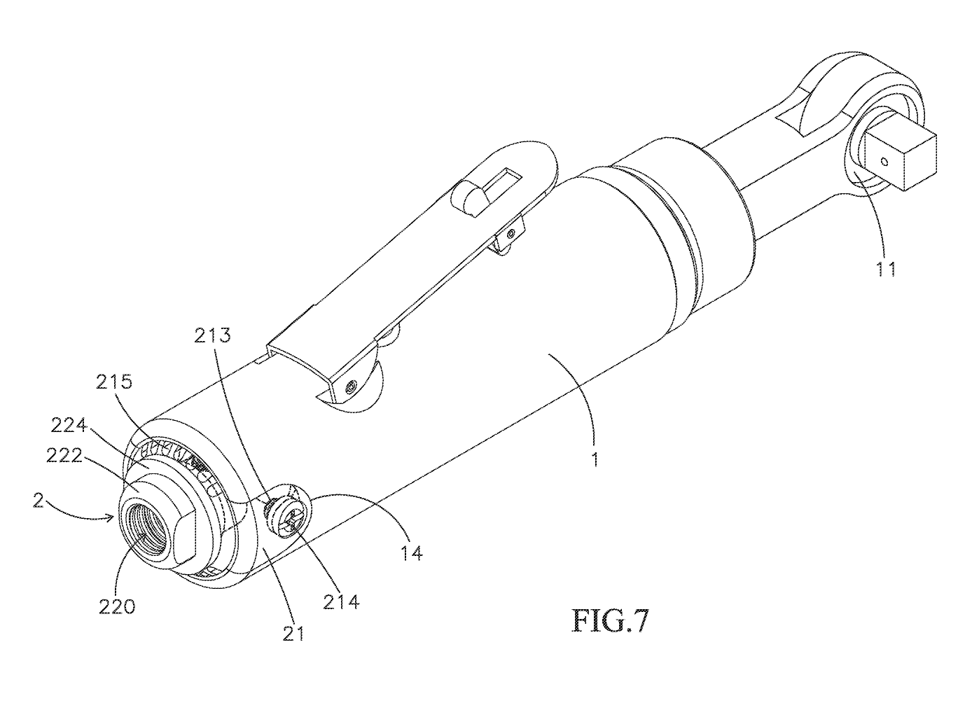

Referring also to FIGS. 6 and 7, the pneumatic tool assembly 1 of the present invention can be embodied as various types of pneumatic tools as shown in the drawings.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

What is claimed is:

1. A self-oiling pneumatic tool, comprising a pneumatic tool assembly, the pneumatic tool assembly comprising a driver unit arranged therein, the pneumatic tool assembly having an end forming an air connection terminal, characterized in that:
an oiling unit is arranged between the driver unit and the air connection terminal and the oiling unit comprises an outer tube and an inner tube, the outer tube hermetically enclosing outside the inner tube in such a way that an oil preservation space is formed between the outer tube and the inner tube, the inner tube comprising a passage formed therein, the passage being in communication with the driver unit, the inner tube having a circumferential wall in which at least one second oil supply aperture is formed, the second oil supply aperture being in communication with the passage.

2. The self-oiling pneumatic tool according to claim 1, wherein a receiving space is formed between the driver unit and the air connection terminal and the oiling unit is arranged in the receiving space.

3. The self-oiling pneumatic tool according to claim 1, wherein the pneumatic tool assembly comprises at least one hollowed section formed in an external wall thereof at a location corresponding to the outer tube.

4. The self-oiling pneumatic tool according to claim 1, wherein the outer tube comprises a transparent or translucent tube.

5. The self-oiling pneumatic tool according to claim 1, wherein the outer tube has an end forming a first opening and an opposite end forming a second opening, the inner tube having an end forming a first coupling end and an opposite end forming a second coupling end, the first coupling end facing the driver unit of the pneumatic tool assembly, the second coupling end corresponding to the air connection terminal of the pneumatic tool assembly, the inner tube comprising a first sealing section mounted thereon at a location adjacent to the first coupling end, the inner tube comprising a second sealing section mounted thereto at a location adjacent to the second coupling end, the first sealing section having an outside diameter that is greater than an inside diameter of the first opening in order to close and seal the first opening, the second sealing section having an outside diameter that is greater than an inside diameter of the second opening in order to close and seal the second opening.

6. The self-oiling pneumatic tool according to claim 5, wherein the outer tube has a circumferential wall in which at least one first oil supply aperture is formed at a location between the first opening and the second opening, the first oil supply aperture extending into the outer tube and communicating with the oil preservation space, the outer tube comprising a sealing member, the sealing member being mounted in the first oil supply aperture.

7. The self-oiling pneumatic tool according to claim 5, wherein the first coupling end and the second coupling end of the inner tube are in communication with the passage, the second oil supply aperture of the inner tube being located between the first coupling end and the second coupling end, the second oil supply aperture being in communication with the oil preservation space.

8. The self-oiling pneumatic tool according to claim 1, wherein the outer tube comprises a plurality of air guide holes formed in an outside surface thereof, the air guide holes being arranged side by side.

9. The self-oiling pneumatic tool according to claim 1, wherein the inner tube comprises a plug, the plug being mounted in the second oil supply aperture, the plug being of permeability.
